(19) United States
(12) Patent Application Publication
(10) Pub. No.: US 2006/0055185 A1
(43) Pub. Date: Mar. 16, 2006

(54) Door outer handle opening operation prevention structure

(75) Inventors: Takeki Tanaka, Kawachi-gun (JP); Kazuya Shibata, Utsunomiya-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/210,480

(22) Filed: Aug. 24, 2005

(30) Foreign Application Priority Data
Aug. 31, 2004 (JP) 2004-252686

(51) Int. Cl. E05B 3/00

(52) U.S. Cl. 292/336.3

(57) ABSTRACT

An opening operation prevention structure for a door outer handle includes a base plate, a side wall that projects from the base plate, and a handle lever that is rotatably supported by the side wall. The side wall includes an extension that covers the exterior of the handle lever when the base plate is viewed in a side view.

### BACKGROUND OF THE INVENTION

Priority is claimed on Japanese Patent Application No. 2004-252686, filed Aug. 31, 2004, the contents of which are incorporated herein by reference.

1. Field of the Invention

The present invention relates to a door outer handle opening operation prevention structure for preventing the opening of a back door of a vehicle such as an automobile, due to erroneous operation of a door outer handle attached to the back door.

2. Description of Related Art

For example, in a vehicle such as an automobile, there is one where an opening operation prevention structure is employed for a door outer handle, so that a door is not opened erroneously when it receives an impact (for example, refer to Japanese Unexamined Patent Application, First Publication No. 10-297279).

In this conventional opening operation prevention structure, there is provided with a weight that is moved to a lock position by inertial force when an impact acts thereon. By fixing this weight in a position where the weight interferes with the rotation locus of a handle arm of the door outer handle, the opening operation of the handle arm is prevented.

However, in the conventional technique, there is a problem in that since the weight and related parts are required, the structure becomes complicated and the number of parts is increased.

The present invention takes the above problem into consideration, with an object of providing a door outer handle opening operation prevention structure that can reliably prevent the opening operation of the door outer handle, with a simple structure without increasing the number of parts.

### SUMMARY OF THE INVENTION

In order to achieve the above object, the present invention adopts an opening operation prevention structure for a door outer handle of the invention including: a base plate; a side wall that projects from the base plate; and a handle lever that is rotatably supported by the side wall, wherein the side wall is furnished with an extension that covers the exterior of the handle lever when the base plate is viewed in a side view.

By having such a structure, even if a peripheral part comes close to the vicinity of the handle lever due to an impact, since the extension that projects from the side wall of the base plate which supports the handle lever collides with the peripheral part, reaching of the peripheral part to the handle lever can be prevented. As a result, collision of the peripheral part with the handle lever and rotation in the open direction can be prevented. Consequently, the opening operation of the door outer handle can be reliably prevented with a simple structure without increasing the number of parts.

The side wall may be provided on both ends of the base plate.

In this case, it is possible to prevent collision of the peripheral part with the handle lever due to the impact, at the both sides of the base plate. Consequently, the opening operation of the door outer handle can be reliably prevented with a simple structure without increasing the number of parts.

The extension may be provided so that when the base plate is viewed from the front, it is separated further outwards than the handle lever.

In this case, the extensions can be kept from blocking the rotation operation of the handle lever. Therefore, the normal operation of the handle lever can be smoothly performed.

The extension may be covered with a handle cover garnish.

In this case, the extensions can be kept from being seen from the outside. Therefore, there is an effect in that the appearance quality can be improved.

A position of a tip of the extension, and a position of a tip edge of the handle lever may be in the same position.

In this case, it becomes possible to project the tip edge of the handle lever to the maximum. Therefore, the operability of the handle lever can be improved while preventing erroneous opening operation of the handle lever by means of the extension.

### BRIEF DESCRIPTION OF THE DRAWINGS

FIG. 1 is a rear perspective view of a vehicle comprising a door outer handle opening operation prevention structure according to an embodiment of the present invention.

FIG. 2 is a cross-sectional view taken along the line A-A of FIG. 1.

FIG. 3 is a perspective view of a door outer handle.

FIG. 4 is a cross-sectional explanatory view showing a deformed license garnish.

### DETAILED DESCRIPTION OF THE INVENTION

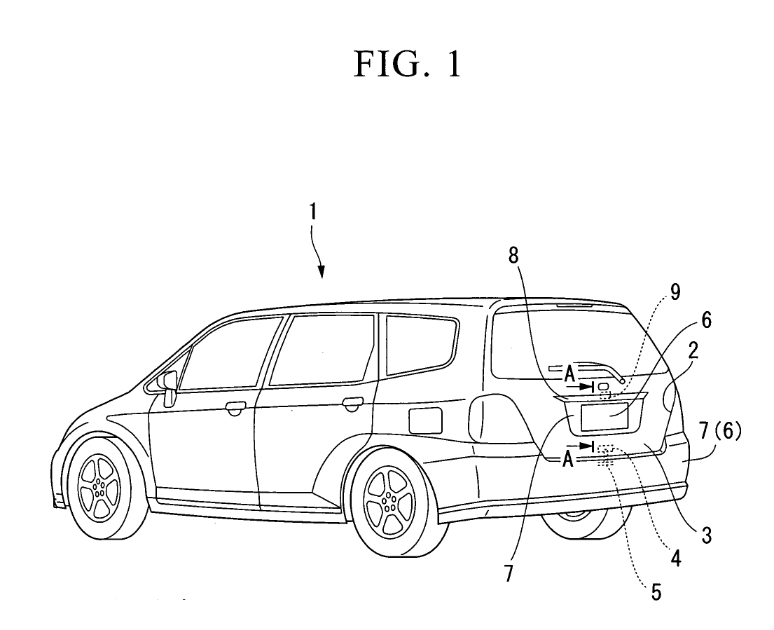

Hereunder is a description of an embodiment of an opening operation prevention structure for a door outer handle of the present invention, with reference to the drawings. FIG. 1 is a rear perspective view of a door outer handle opening operation prevention structure according to the present embodiment, applied to a tailgate, being the back door of a vehicle. As shown in FIG. 1, a tailgate 3 is provided at a rear opening 2 of a vehicle body 1 so as to be capable of opening and closing. A locking device 4 is attached at the vehicle widthwise center on the lower side of the tailgate 3. Corresponding to the locking device 4, a striker 5 is attached to the rear opening 2. When the tailgate 3 is closed, the striker 5 is latched with the locking device 4, so that the closed (latched) state of the tailgate 3 is maintained.

On the lower half of the tailgate 3, an attaching portion 7 for a license plate 6 is provided as a recess of an approximate inverted trapezoidal shape. On the upper portion of the attaching portion 7, is provided a door outer handle 9 at a position that is hidden from the outside due to being covered with a handle cover garnish 8 described later. By the opening operation of the door outer handle 9, the latched state of the locking device 4 and the striker 5 is released, and the tailgate 3 is opened.

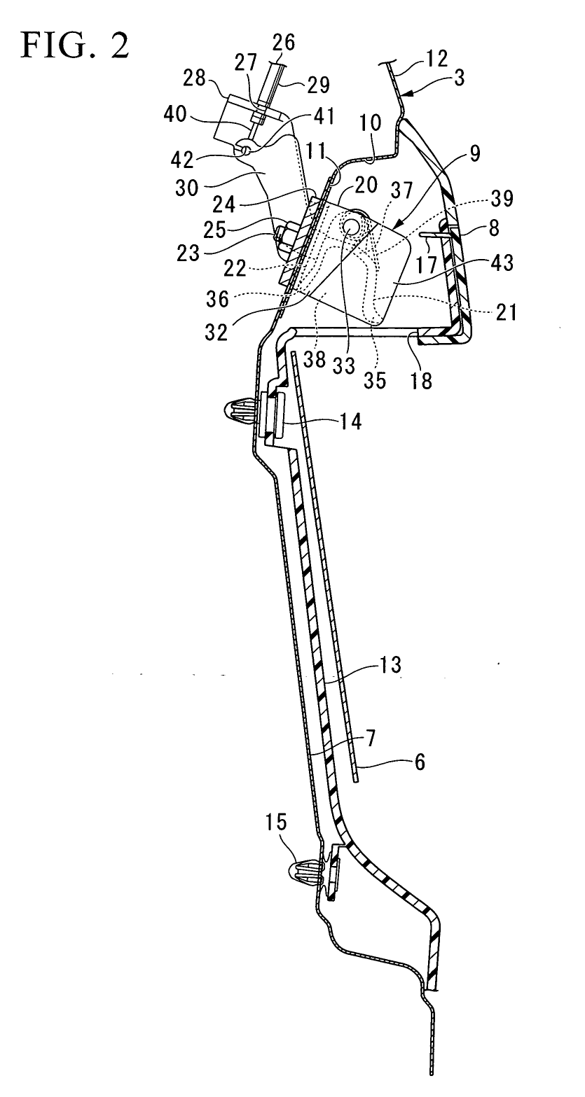

As shown in FIG. 2, an outer panel 10 of the tailgate 3 has an attachment face 11 for the door outer handle 9 on an upper portion of the attaching portion 7 for the license plate 6. A plastics handle cover garnish 8 is attached in a position continuous with the general face 12 of the outer panel 10, on the upper edge of the attachment face 11. A plastics license garnish (peripheral part) 13 is fixed by clips 14 and 15 to the attaching portion 7 for the license plate 6 of the outer panel 10 so as to cover it. An upper portion of the license garnish 13 is formed bent in a crank shape. It is projected to the outside, then bent up while overlapping the backside of a bent portion 16 of the handle cover garnish 8, and is then latched to a latch projection 17 of the handle cover garnish 8. A license plate 6 is fixed to the upper face of the license garnish 13 by bolts (not shown). In the crank shaped portion of the license garnish 13, a later described opening 18 for operating the door outer handle 9 is formed.

The door outer handle 9 is attached to the attachment face 11 on the outer panel 10.

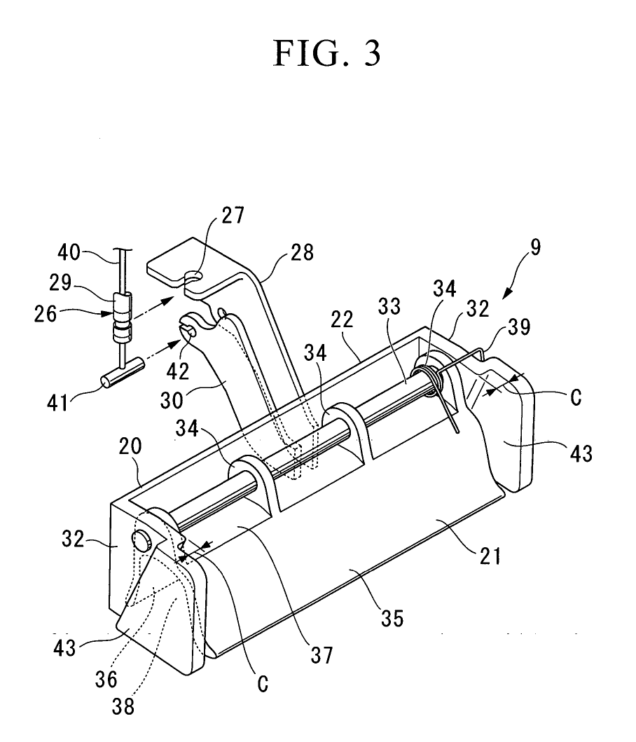

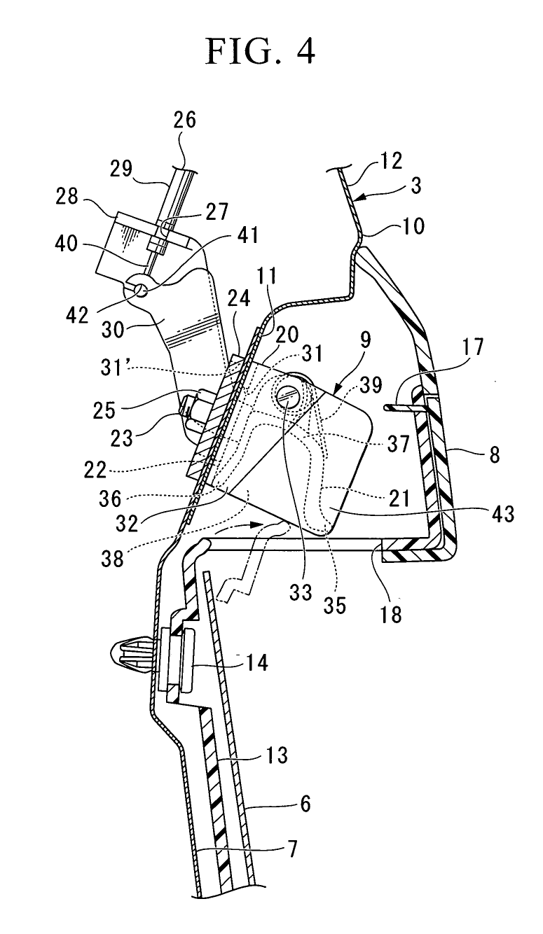

As shown in FIGS. 3 and 4, the door outer handle 9 includes a base plate 20, and a handle lever 21 that is rotatably supported on the base plate 20. The base plate 20 is a metal member, with stud bolts 23 (not shown in FIG. 3) provided on a rear wall 22 thereof. The stud bolts 23 are inserted into a back plate 24 that is provided on the backside of the outer panel 10, passing through the outer panel 10. Furthermore, they are fastened from the backside of the outer panel 10 by nuts 25.

The back plate 24 is provided with an arm 28 formed with a clamp portion 27 for latching a latch releasing cable 26. The arm 28 is formed so that it rises upward, and an upper end thereof is bent in the vehicle widthwise direction. Here, the clamp portion 27 is formed for latching an outer tube 29 of the latch releasing cable 26. A later mentioned arm 30 of the handle lever 21 is inserted through the rear wall 22 of the base plate 20, and the back plate 24, and notches 31 and 31′ are formed for allowing vertical movement of the arm 30 (refer to FIG. 4).

Side walls 32 that project backwards in the vehicle traveling direction, are respectively formed on both ends of the rear wall 22 of the base plate 20. The handle lever 21 is rotatably supported between these side walls 32. Specifically, a shaft 33 is inserted, in the vehicle widthwise direction, between the respective side walls 32, and the handle lever 21 is rotatably supported on the shaft 33. A plurality of (four in the example shown in the drawing) support brackets 34 through which the shaft 33 is inserted, are provided on an upper portion of the handle lever 21. Moreover, the lower portion of the handle lever 21 is formed so that an operator's fingers can readily enter.

The handle lever 21 is formed in an approximate U-shape in cross-section, by an outer piece 35, an inner piece 36, and a top wall 37 having the respective support brackets 34, and a receiving region 38 is formed thereinside.

An edge portion of the outer piece 35 is formed in a curve so as to rise up slightly. Between the outer piece 35 and the side wall 32 of the base plate 20, is provided a torsion spring 39 that urges from a latch release position (opening operation position) towards a standby position. The inner piece 36 is integrally formed with the swing arm 30 which projects through the notches 31 and 31′ formed in the rear wall 22 of the base plate 20, and in the back plate 24. An engagement hole 42 through which a latch end 41 of an inner wire 40 of a latch releasing cable 26, is inserted to latch therewith, is formed in a tip end of the swing arm 30.

In a portion enclosing the axial opposite ends of the handle lever 21 in the standby position, on the respective side walls 32 is respectively provided with extensions 43 projecting outwards in the vehicle widthwise direction away from the handle lever 21. These extensions 43 are provided axially outside of the handle lever 21, that is, so as to be mutually separated along the vehicle widthwise direction. As a result, when viewed from the rear of the vehicle body, a certain level of clearance C (refer to FIG. 3) is ensured respectively between the axial opposite ends of the handle lever 21 and the extensions 43. Moreover, when viewed in a side view as shown in FIGS. 2 and 4, the tips of the respective extensions 43, and the tip edge of the handle lever 21 are provided so as to be in approximately the same position so that the handle lever 21 does not protrude from the extensions 43.

The handle cover garnish 8 is arranged on the vehicle longitudinal rear side of the extensions 43, and the extensions 43 are covered with this handle cover garnish 8.

According to the present embodiment, when the handle lever 21 is pulled, the inner wire 40 of the latch releasing cable 26 is pulled via the swing arm 30 attached to the inner piece 36. As a result, the latched state between the locking device 4 and the striker 5 is released, and the tailgate 3 is operated to open.

Here, for example, in a case where due to an impact applied to the rear of the vehicle body 1, the edge of the opening 18 of the license garnish 13 is deformed as shown by the chain line arrow in FIG. 4, and is moved towards the vicinity of the handle lever 21 of the door outer handle 9, specifically towards the outer piece 35 of the handle lever 21, if the extensions 43 are not provided, then the handle lever 21 might be rotated by the edge of the license garnish 13 which is moved as is. However, in the present embodiment, the license garnish 13 abuts against the respective extensions 43, and hence the license garnish 13 is reliably kept from entering any farther.

Therefore, a situation where the edge of the license garnish 13 is collide with the handle lever 21 and rotates the handle lever 21 in the open direction to thereby release the latched state between the locking device 4 and the striker 5 does not arise. As a result, the opening operation of the door outer handle 9 can be reliably prevented, with a simple structure without increasing the number of parts.

Furthermore, since the extensions 43 are provided as a pair on the side walls 32 on the both ends of the base plate 20, the license garnish 13 moving towards the handle lever 21 due to impact can be stopped at two points on the both ends of the base plate 20. Accordingly, the opening operation of the door outer handle 9 can be more reliably prevented.

Furthermore, the extensions 43 are provided axially outside of the handle lever 21, that is, so as to be mutually separated towards the vehicle widthwise outside. Moreover, when viewed from the rear of the vehicle body, a certain level of clearance C is ensured between the axial opposite ends of the handle lever 21 and the extensions 43. As a result, the extensions 43 do not block the rotation operation of the handle lever 21, and do not negatively affect the normal operation of the handle lever 21.

Furthermore, when the handle lever 21 is viewed in a side view, the tips of the extensions 43 and the tip edge of the handle lever 21 are provided in approximately the same position such that the handle lever 21 does not protruded from the extensions 43. As a result, it becomes possible to project the tip edge of the handle lever 21 to the maximum, and hence the force to operate the handle lever 21 can be minimized, and the operability can be improved, while preventing erroneous opening operation of the handle lever 21 by means of the extensions 43.

The present invention is not limited to the above embodiment, and may be applied to, for example, a side door or a bonnet, rather than the tailgate 3. Moreover, it is not limited to a vehicle such as an automobile, and may be applied to a vending machine, an electrical appliance, and the like, as long as it includes a door.

While a preferred embodiment of the invention has been described and illustrated above, it should be understood that this is exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A door outer handle opening operation prevention structure comprising:
a base plate; a side wall that projects from said base plate; and
a handle lever that is rotatably supported by said side wall, wherein
said side wall includes an extension that covers the exterior of said handle lever when said base plate is viewed in a side view.

2. A door outer handle opening operation prevention structure according to claim 1, comprising another said side walls, and said side walls are respectively provided on ends of said base plate.

3. A door outer handle opening operation prevention structure according to claim 1, wherein, when said base plate is viewed from the front, said extension is spaced further outwards than said handle lever.

4. A door outer handle opening operation prevention structure according to claim 1, wherein said extension is covered with a handle cover garnish.

5. A door outer handle opening operation prevention structure according to claim 1, wherein a position of a tip of said extension, and a position of a tip edge of said handle lever are the same when viewed in the side view.

6. A door outer handle opening operation prevention structure according to claim 1, wherein, when said base plate is viewed from the front, said side wall is spaced outwards of said handle lever, and said extension is spaced further outwards of said handle lever.

7. A door outer handle opening operation prevention structure according to claim 1, wherein said base plate and said side wall are integrally formed as a unitary member.

8. A door outer handle opening operation prevention structure according to claim 1, wherein said handle lever is substantially U-shaped in section, normally opening downwardly.

9. A door outer handle opening operation prevention structure according to claim 1, wherein the structure is adapted to be placed on a rear door of a vehicle.

10. A door outer handle opening operation prevention structure comprising:
a base plate; a pair side wall that project from said base plate; and
a handle lever that is rotatably supported by said side walls, wherein
each said side wall includes an extension that covers the exterior of said handle lever when said base plate is viewed in a side view, and which prevents the handle lever from being unintentionally operated in the event of a collision.

11. A door outer handle opening operation prevention structure according to claim 10, wherein, when said base plate is viewed from the front, said extensions are spaced further outwards than said handle lever.

12. A door outer handle opening operation prevention structure according to claim 10, wherein said extensions are covered with a handle cover garnish.

13. A door outer handle opening operation prevention structure according to claim 10, wherein a position of a tip of each said extension, and a position of a tip edge of said handle lever are the same when viewed in the side view.

14. A door outer handle opening operation prevention structure according to claim 10, wherein, when said base plate is viewed from the front, said side walls are spaced outwards of said handle lever, and said extensions are spaced further outwards of said handle lever.

15. A door outer handle opening operation prevention structure according to claim 10, wherein said base plate and said side walls are integrally formed as a unitary member.

16. A door outer handle opening operation prevention structure according to claim 10, wherein said handle lever is substantially U-shaped in section, normally opening downwardly.

17. A door outer handle opening operation prevention structure according to claim 10, wherein the structure is adapted to be placed on a rear door of a vehicle.
